(19) United States
(12) Patent Application Publication
(10) Pub. No.: US 2025/0299849 A1
(43) Pub. Date: Sep. 25, 2025

(54) ELECTRICALLY INSULATED CONDUCTORS

(71) Applicant: Dupont Electronics, Inc., Wilmington, DE (US)

(72) Inventors: LEOPOLDO ALEJANDRO CARBAJAL, WILMINGTON, DE (US); ROSS JOHNSON, WILMINGTON, DE (US); MICHAEL FRANZ MULZER, CIRCLEVILLE, OH (US); ERIC KANICKI, ALPHARETTA, GA (US)

(21) Appl. No.: 19/080,258

(22) Filed: Mar. 14, 2025

Related U.S. Application Data
(60) Provisional application No. 63/567,294, filed on Mar. 19, 2024.

(51) Int. Cl. H01B 7/02; H01B 1/02; H01B 3/12; H01B 3/30

(52) U.S. Cl. CPC H01B 7/0225; H01B 1/02; H01B 3/12; H01B 3/30

(57) ABSTRACT

In a first aspect, an electrically insulated conductor includes an electrically conductive core and an insulating wrap around the electrically conductive core. The insulating wrap includes a base film tape. The base film tape includes a polymer core layer and a first thermoplastic polymer outer layer adhered to a first side of the polymer core layer. The polymer core layer and the first thermoplastic polymer outer layer each have a glass transition temperature (T_{g}) of 200° C. or higher. A ratio of a bending radius (R) to a width (W) of the insulated conductor is in a range of from 0.8:1 to 2:1. An interlaminar fracture toughness (G_{lc}) of the first thermoplastic polymer outer layer to the conductive core is 200 J/m² or more.

### FIELD OF DISCLOSURE

The field of this disclosure is electrically insulated conductors.

### BACKGROUND OF THE DISCLOSURE

Electrically insulated conductors are used in electric motors for vehicles. In smaller vehicles like cars, the small motor size creates unique challenges for the electrical insulation because of the confined geometry. There is a need for wire insulation that can withstand tight bending geometries used in these smaller sized electric motors. There is also a need to eliminate fluorinated materials used in some insulations due to environmental concerns.

Modern electric motors are also demanding ever-increasing performance for electrically insulated conductors, such as polymer-wrapped wires. As systems are designed for operation at higher voltages over long periods of time, the need for corona resistant films is increasingly important. These films, when used as wire insulation material, need to maintain both good electrical properties (e.g., voltage endurance) and mechanical properties (e.g., scrape abrasion and dynamic cut through). Typically, a wire will be bent into various shapes or directions, and the corona resistant film covering the wire needs to have the ability to do the same. The addition of filler to corona resistant films can negatively impact their mechanical properties, and the films can become more brittle (lower tensile strength and elongation).

Corona-resistant films have previously been used in magnet wire constructions for traction motors, i.e., wire consisting of a singular copper strand, the surface of which is covered with an insulating film material. In higher voltage applications, performance shortcomings of the insulation material might be overcome by using thicker layers of insulation wrap, but this adds undesirable bulk and weight to the wrapped wire. A need exists for improved electrically insulative, corona resistant films that can endure the demands of higher voltage, such as aerospace applications, and can do so while limiting the form factor of the film.

### DETAILED DESCRIPTION

In a first aspect, an electrically insulated conductor includes an electrically conductive core and an insulating wrap around the electrically conductive core. The insulating wrap includes a base film tape. The base film tape includes a polymer core layer and a first thermoplastic polymer outer layer adhered to a first side of the polymer core layer. The polymer core layer and the first thermoplastic polymer outer layer each have a glass transition temperature (T_{g}) of 200° C. or higher. A ratio of a bending radius (R) to a width (W) of the insulated conductor is in a range of from 0.8:1 to 2:1. An interlaminar fracture toughness (G_{lc}) of the first thermoplastic polymer outer layer to the conductive core is 200 J/m² or more.

A polyimide film having an electrically insulative, corona resistant composite filler can be formed from a substantially chemically converted polyimide or a thermally converted polyimide. Polyimide films with electrically insulative, corona resistant composite filler can be made through careful selection of the dianhydride and diamine monomers used for the polyimide backbone.

As used herein, the term “substantially chemically converted” means that a polyimide is 75% or more, 80% or more, 85% or more, 90% or more, or 95% or more imidized using a process incorporating conversion chemicals (i.e., catalysts and dehydrating agents) in which a solvated mixture (a polyamic acid casting solution) can be cast or applied onto a support to give a partially imidized gel film, and then heated in an oven, using convective and radiant heat, to remove solvent and complete the imidization. Percent imidization can be measured by comparing a ratio of intensities at 1365 cm⁻¹ (polyimide C—N) relative to 1492 cm⁻¹ (aromatic stretch used as an internal standard) in Attenuated Total Reflectance Fourier Transform Infra-Red (ATR-FTIR) spectroscopy and comparing the ratio to that of a sample prepared with standard curing methods that is defined as being 100% cured.

Depending upon context, “diamine” as used herein is intended to mean: (i) the unreacted form (i.e., a diamine monomer); (ii) a partially reacted form (i.e., the portion or portions of an oligomer or other polymer precursor derived from or otherwise attributable to diamine monomer) or (iii) a fully reacted form (the portion or portions of the polymer derived from or otherwise attributable to diamine monomer). The diamine can be functionalized with one or more moieties, depending upon the particular embodiment selected in the practice of the present invention.

Indeed, the term “diamine” is not intended to be limiting (or interpreted literally) as to the number of amine moieties in the diamine component. For example, (ii) and (iii) above include polymeric materials that may have two, one, or zero amine moieties. Alternatively, the diamine may be functionalized with additional amine moieties (in addition to the amine moieties at the ends of the monomer that react with dianhydride to propagate a polymeric chain). Such additional amine moieties could be used to crosslink the polymer or to provide other functionality to the polymer.

Similarly, the term “dianhydride” as used herein is intended to mean the component that reacts with (is complimentary to) the diamine and in combination is capable of reacting to form an intermediate (which can then be cured into a polymer). Depending upon context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e. a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polymer composition reacted from or otherwise attributable to dianhydride monomer) or (iii) a fully reacted form (the portion or portions of the polymer derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polymer). Such additional anhydride moieties could be used to crosslink the polymer or to provide other functionality to the polymer.

Any one of a number of polymer manufacturing processes may be used to prepare polymer films. It would be impossible to discuss or describe all possible manufacturing processes useful in the practice of the present invention. It should be appreciated that the monomer systems of the present invention are capable of providing the above-described advantageous properties in a variety of manufacturing processes. The compositions of the present invention can be manufactured as described herein and can be readily manufactured in any one of many (perhaps countless) ways of those of ordinarily skilled in the art, using any conventional or non-conventional manufacturing technology.

Although methods and materials similar or equivalent to those described herein can be used in the practice or testing of the present invention, suitable methods and materials are described herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers, it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

It will be understood that although the terms first, second, third, etc. may be used herein to describe various elements, components, regions, layers and/or sections, these elements, components, regions, layers, and/or sections should not be limited by these terms. These terms are only used to distinguish one element, component, region, layer and/or section from another element, component, region, layer and/or section. Thus, a first element, component, region, layer and/or section could be termed a second element, component, region, layer and/or section without departing from the teachings of the present invention. Similarly, the terms “top” and “bottom” are only relative to each other. It will be appreciated that when an element, component, layer or the like is inverted, what is the “bottom” before being inverted would be the “top” after being inverted, and vice versa. When an element is referred to as being “on” or “disposed on” another element, it means positioning on or below the object portion, but does not essentially mean positioning on the upper side of the object portion based on a gravity direction, and it can be directly on the other element or intervening elements may be present therebetween. In contrast, when an element is referred to as being “directly on” or “disposed directly on” another element, there are no intervening elements present.

Further, it will also be understood that when one element, component, region, layer and/or section is referred to as being “between” two elements, components, regions, layers and/or sections, it can be the only element, component, region, layer and/or section between the two elements, components, regions, layers and/or sections, or one or more intervening elements, components, regions, layers and/or sections may also be present.

### Hairpin Bending Requirements

Hairpin winding technology is becoming more common in the design of electric motors (e-motors) for electrical vehicles, especially for traction motor applications requiring high power density. Compared to other technologies such as motors based on round wire windings, hairpin motors can have higher copper fill factors, thus allowing higher power density, and better thermal management performance.

Another common design shift in e-motors is an increase in the system voltage to higher operating voltages. Maintaining the integrity of the electrical insulation around conductive elements in an electric motor is crucial to prevent short-outs to ground in the e-motor which otherwise would render the entire e-motor useless as insulation failures cannot be repaired easily.

Hairpins are typically produced from straight conductive elements (e.g., a copper wire) that bear an electrically insulative material (made up of one or more distinct layers) around it. These elements are usually supplied in continuous form, and therefore first cut into individual pieces which subsequently are formed into the shape of a hairpin. The forming process itself can take various forms, e.g., a single-stage process or a multiple stage process. The shape of the hairpins is dictated by their desired arrangement in the stator of the e-motor. The geometry of the hairpin can be described by a series of bends around defined radii, wherein the severity of a given bent section can be described by the ratio of the bending radius (R) of the bent section and the width (W) of the conductive element section (including any insulative materials) subject to bending. A smaller ratio corresponds to a more severe bend, which in turn places a higher requirement on the mechanical properties of the insulative material as well as its adhesion to the conductive element. More severe bends are more likely to trigger mechanical failures in the insulative material such as wrinkling, puckering, delamination, etc. as a result of the mechanical strain imposed on the insulative materials during the bending process exceeding the mechanical properties of the insulative material. Given the current trend to shrink the size of electrical motors, it is becoming increasingly important that the insulative material is capable of damage-free forming for ratios of R/W less than 1, preferably less than 0.8.

If a given R/W value is provided, methods and equations known to the field of engineering can be applied to determine theoretical minimum mechanical properties that an insulative material needs to possess to pass the hairpin forming without visible damage. Determining these minimum mechanical properties also needs to consider that the insulative material can be applied and be present in various arrangements, e.g., a seamless or overlapping tape spirally wrapped around the conductive element, a seamless overlapping or non-overlapping tape wrapped longitudinally around the conductive element, a varnish/enamel-type of coating, or an extruded layer, and combinations of these. In one embodiment, an overlapping tape spirally wrapped around the conductive element or a seamless overlapping or non-overlapping tape wrapped longitudinally around the conductive element is preferred.

To be able to attain damage free forming, the insulation must have certain mechanical and structural properties.

The elongation at break (also known as strain at break, ultimate strain, percent elongation at break, or tensile elongation at break) of the insulative material must be sufficiently high to survive the strains that are generated during the bending operations during hairpin formation.

For spirally wrapped insulations, there are several strain intensification points that arise in the regions near the overlaps and there is no equation that allows the accurate evaluation of the strains on the insulation as a function of the variables of interest. Nonlinear finite element models that explicitly capture the geometry of the insulation on the conductor can be used to calculate the elongation at break requirements for the range of geometries of interest. In one embodiment, an insulative material possesses a minimum elongation at break value of at least 60% to accommodate bends with R/W in a range of from 0.8:1 to 2:1, or from 0.8:1 to 1.5:1, or from 0.8:1 to 1.2:1.

In addition to having a minimum elongation at break value, the insulative material must have strong interfaces to avoid debonding or loss of adhesion from either the conductor or from itself during the hairpin forming process. The adhesive interlaminar fracture toughness is the structural mechanical property that quantifies the strength of interfaces. There is no equation that allows the calculation of the interlaminar fracture toughness as a function of the geometric and materials properties. Nonlinear finite elements models that explicitly capture the geometry of the insulation on the conductor and the interfaces in the structure can be used to calculate the requirements for the range of geometries and material mechanical properties of interest. In one embodiment, an insulative material adhered to the conductive element possesses a minimum interlaminar fracture toughness (G_{lc}) of 200 J/m² or more, 250 J/m² or more, 300 J/m² or more, or 400 J/m² or more. In another embodiment, the insulative material itself consists of two or more distinct layers and any two layers within the insulative material are adhered to one another with a minimum G_{lc} of 140 J/m² or more, 175 J/m² or more, 200 J/m² or more, or 250 J/m² or more. In another embodiment, the insulative material is adhered to itself, for example as part of an insulative material spirally wrapped around a conductive element, with a minimum G_{lc} of 140 J/m² or more, 175 J/m² or more, 200 J/m² or more, or 250 J/m² or more.

In cases where the G_{lc} exceeds a certain value, one can consider that interface to be no longer relevant regarding adhesion failures because cohesive failure modes start to compete as a reason for overall material failure. In one embodiment, if the G_{lc} between two materials exceeds 700 J/m², it is no longer considered to be an interface that can experience adhesive material failure.

Two experimental methods were used to obtain the interlaminar fracture toughness of interest. The Double Cantilever Beam—Experimental Compliance Method described by B. R. K. Blackman and A. J. Kinloch, “Fracture Tests for Structural Adhesive Joints”, in “Fracture Mechanics Testing Methods for Polymers, Adhesives and Composites”, Eds. A. Pavan, D. R. Moore and J. G. Williams, (Elsevier Science, Amsterdam, 2001), was used to measure the interlaminar fracture toughness in Mode I (G_{lc}) of most of the insulation-to-insulation interfaces. In cases were the debonding took place at the substrate interface instead of the insulation-to-insulation interface, the G_{lc} value is reported as greater than the value obtained using this test method. T-peel and 90-degree peel tests were used to derive the interlaminar fracture toughness of some insulation-to-insulation interfaces and for all the insulation-to-conductor interfaces. Even though peel strength is often reported as a measurement of the strength of interfaces, it is not as good of a quantitative measure because it has contributions from other deformations modes (stored strain energy in the peel arm, energy dissipated due to tensile deformation of the peel arm and energy due to bending of the peel arm). For a more detailed discussion about this topic, one can refer to Kinloch, A. J., Lau, C. C. & Williams, J. G. The peeling of flexible laminates. Int J Fract 66, 45-70 (1994). The method used to recover the interlaminar fracture toughness was like the one described in the paper by Kinloch et al., but instead of using equations, finite element models of the peel tests were employed for a more accurate accounting of the material responses. In cases of multilayer insulative materials where the delamination propagated from the conductor-film interface to an interface inside the multilayer insulative material, the values are reported as greater than the value obtained using this method.

In cases of a multilayer insulative material in which a compliant insulative layer is adhered to one or more stiffer insulative layers, the compliant layer can develop high shear strains during bending operations. To avoid high shear strains and excessive deformation of a single layer in the insulative material when high transverse loads are experienced, it is recommended to employ only materials with similar moduli as part of a multilayer insulative material. In one embodiment, the ratio of the tensile moduli between two adjacent layers in a multilayer insulative material is 0.5:1 or more, 0.6:1 or more, or 0.7:1 or more when dividing the smaller tensile modulus numerical value of a first layer by the larger tensile modulus numerical value of a second layer.

### Electrically Insulative Materials

Materials suitable for electrically insulating conductive elements include thermoplastic and thermoset polymers. Within this set of materials, polymers that possess a high thermal rating, e.g., a high relative temperature index (RTI) as defined by UL or IEEE, a high temperature index according to ASTM D2304, or a high thermal class according to IEC 60085 or NEMA class, or NEMA/UL letter class. In one embodiment, the electrically insulative material has a thermal class of 200° C. or greater.

Specific examples of material classes that possess a high thermal rating include polyimide (PI), poly(amide-imide) (PAI), polyaryletherketone (PAEK) (which include PEK (polyetherketone), PEKK (polyetherketoneketone), PEEK (polyetheretherketone), polyphenylene sulfide (PPS), a polyphenylene sulfone (PPSU), a polyether sulfone (PES), a polyetherimide (PEI), polyester-imides (PEI), or mixtures thereof. In one embodiment, electrically insulative materials based on polyimide (PI) are used. In one embodiment, the insulative material consists of two or more layers of polyimide materials in which the chemical nature of each polyimide layer may be the same of different. In one embodiment, multilayers consisting of two or three layers of polyimide materials are used. In one embodiment, a multilayer polyimide material is used in which the outermost layers are chemically identical. In one embodiment, a polyimide material with a residual organic solvent content of 1 wt % or less, 0.8 wt % or less, 0.5 wt % or less, or 0.3 wt % or less is used. In one embodiment, electrically insulative materials based on polyimide (PI) in the form of a tape and usable in a longitudinal or spiral wire wrap process are used. In another embodiment, electrically insulative materials based on polyimide (PI) are free of or not in contact with other material classes such as silicones or fluoropolymers such as PTFE, FEP, or PFA.

While the aforementioned materials may form the majority of the electrically insulative material weight- and volume-wise, other material classes may be presented as minor components in the electrically insulative material to improve adhesion or scrape abrasion resistance or friction or other properties of the major insulative material that are relevant to this application. These material classes may individually have a thermal class of 200° C. and above, but also lower than 200° C. These minor components may be present intermixed either macroscopically or microscopically with the majority of the electrically insulative material, or they may be present as a separate layer or component around the conductive element, as the innermost or outermost layer, or as a layer separating two or more layers of the major insulative material.

Based on the theoretically derived mechanical properties that an electrically insulative material should possess in order to survive a hairpin forming process described by a certain set of R/W values of 0.8 or greater without visible damage, the tensile properties of a range of polyimide materials were characterized according to ASTM D882-18 and are summarized in Table 1.

TABLE 1

| | | | | | Tensile | |
|---|---|---|---|---|---|---|
| | | Standard | Elongation | Standard | Strength | Standard |
| | Modulus | Deviation | at Break | Deviation | at Break | Deviation |
| Material | (MPa) | (MPa) | (%) | (%) | (MPa) | (MPa) |
| Polyimide 1 | 3270 | 68 | 110 | 11 | 232 | 20 |
| 100HN | 2700 | 200 | 81 | 10 | 250 | 16 |
| Polyimide 2 | 3040 | 210 | 71 | 7.4 | 166 | 16 |
| Polyimide 3 | 4020 | 210 | 69 | 15 | 230 | 17 |
| Polyimide 4 | 3370 | 260 | 68 | 13 | 225 | 12 |
| 100HA | 3030 | 140 | 68 | 7.2 | 195 | 19 |
| Polyimide 5 | 4480 | 480 | 56 | 7.5 | 187 | 20 |
| Polyimide 6 | 5130 | 63 | 44 | 3.8 | 250 | 6.2 |
| Polyimide 7 | 4640 | 350 | 42 | 4.8 | 286 | 18 |
| 50FEP | 364 | 19 | 440 | 4.8 | 26.8 | 0.47 |
| Polyimide 8 | 3460 | 37 | 190 | 3.3 | 249 | 7.3 |
| Polyimide 9 | 2900 | 130 | 130 | 15 | 138 | 10 |

Polyimide 1 is a polyimide film composed of 3,3′,4,4′-biphenyltetracarboxylic dianhydride (BPDA)/pyromellitic dianhydride (PMDA) (in a molar ratio of 1.2:1) and 4,4′-diaminodiphenylether (ODA) having a thickness of ˜25 μm. The film was prepared similar to the procedure described in Example 9 below. The T_{g} of this film was ˜320° C.

100HN is a polyimide film composed of PMDA and ODA having a thickness of ˜25 μm and is commercially available from DuPont de Nemours, Inc. (Wilmington, DE).

Polyimide 2 is a polyimide film composed of PMDA and ODA that additionally contains ˜17 wt % of alumina. The alumina was added to the polyamic acid in the form of a 25 wt % slurry of alumina in DMAc. The film has a thickness of ˜25 μm. The T_{g} of this film was 380° C.

Polyimide 3 and Polyimide 4 are polyimide films composed of PMDA and ODA that additionally contain ˜21 wt % of alumina. The alumina was added to the polyamic acid in the form of a 25 wt % slurry of alumina in DMAc. These films have thicknesses of ˜19 and ˜25 μm, respectively. The T_{g}'s of these films were greater than 380° C.

100HA is a polyimide film composed of PMDA and ODA having a thickness of ˜25 μm and is commercially available from DuPont.

Polyimide 5 is a polyimide film composed of BPDA/PMDA (in a molar ratio of 1.2:1) and ODA having a thickness of ˜25 μm, further containing 17 wt % of alumina. The alumina was added to the polyamic acid in the form of a 25 wt % slurry of alumina in DMAc. The T_{g} of this film was ˜325° C.

Polyimide 6 and Polyimide 7 are polyimide films composed of BPDA/PMDA (in a molar ratio of 1:1.45) and ODA, para-phenylenediamine (PPD)) (in a molar ratio of 1:1.49) having thicknesses of ˜12 and ˜25 μm, respectively. These films were prepared in a similar manner to the procedure described in Example 9 below. The T_{g}'s of these films were ˜350° C.

50FEP is a film of a melt-processible copolymer of tetrafluoroethylene and hexafluoropropylene having a thickness of ˜12 μm and is commercially available from McMaster-Carr (Elmhurst, IL).

Polyimide 8 is a polyimide film composed of 4,4′-oxydiphthalic anhydride (ODPA)/PMDA (in a molar ratio of 4:1) and 1,3-bis(4-aminophenoxy)benzene (RODA) having a thickness of ˜51 μm. The film was prepared as described in Example 9 below. The T_{g} of this film was ˜230° C.

Polyimide 9 is a thermoplastic polyimide film derived from ODPA/PMDA (in a molar ratio of 4:1) and RODA/1,6-diaminohexane (HMD) (in a molar ratio of 2.33:1) having a thickness of ˜75 μm. The film was prepared similar to the procedure described in Example 9 below. The T_{g} of this film was ˜198° C.

A survey of the data presented in Table 1 shows that different combinations of monomers produce polyimide films with different mechanical properties. More specifically, polyimide films containing PMDA and ODA, or incorporating RODA seem more likely to meet or exceed the previously described desirable minimum elongation to break value of 60% or more. Additionally, the inclusion of a filler, specifically alumina, does not deteriorate the elongation to break value of some of these polymers to a point where they would be no longer deemed suitable.

Table 1 also shows that based on the previously described preferred ratio of tensile moduli, not just any two or more (polyimide) materials can be selected to form an insulative (polyimide) multilayer because the range of moduli for the various individual polyimide materials is large and in the most extreme cases can result in ratios of moduli smaller than 0.7 between two materials. Rather, the chemical composition of each polyimide layer in an insulative polyimide multilayer must be carefully selected based on the individual modulus of each polyimide film. It should be noted that the moduli of the materials may also be determined in good approximation by applying ASTM E2546-15 in combination with methods as discussed in, for example, Materials Characterization 58, 380-389 (2007) when performed on base film tapes, after their application to a conductor, or cross-sections thereof.

### Electrically Conductive Core

In one embodiment, an electrically conductive core can include a conductor wire. In one embodiment, a conductor wire can include a conductive metal, such as copper (e.g., copper classified as 10100, 10200 or 11000), copper alloys, silver, silver alloys, aluminum, stainless steel and the like. In one embodiment, the conductor wire may be solid or hollow. In one embodiment, copper can include oxygen-free copper. In one embodiment, copper wire can be coated with a metal or metal alloy plating, such as tin, silver, nickel and mixtures and alloys thereof. In one embodiment, a high-strength copper alloy can be used that resists corrosion and oxidation at high temperatures as well as chemicals, alkalis, hydraulic fluids, and fuel. In one embodiment, the conductor wire may have a rectangular, round, square, stranded, Litz, etc. shape. In one embodiment, the conductor has a rectangular shape with a defined corner radius of 1 mm or less. In one embodiment, the electrical conductor has properties as described in ASTM B250, ASTM B48, ANSI/NEMA MW 1000, and/or IEC 60317.

In one embodiment, an electrically conductive core can include a stranded conductor, such as a high-temperature, multi-stranded conductor wire with individual strands in a range of from 19 to 5000, rated for temperatures up to 260° C. As used herein, the term “stranded conductor” is intended to mean a conductor wire in which multiple strands of uninsulated wires are bundled together to form a single-conductor wire, in contrast to “Litz” wire, in which each strand in a multi-strand is individually insulated. In one embodiment, the individual strands can comprise copper. In one embodiment, copper can include oxygen-free copper. In one embodiment, individual strands of copper can be coated with a metal or metal alloy plating, such as tin, silver, nickel and mixtures and alloys thereof. In one embodiment, a high-strength copper alloy can be used that resists corrosion and oxidation at high temperatures as well as chemicals, alkalis, hydraulic fluids, and fuel. In one embodiment, the size of the multi-stranded conductor wire can be in a range of from AWG (American Wire Gauge) 0000 to AWG 26 (a diameter of the conductor wire ranging from 0.0175 to 0.6050 inches (0.445 to 15.4 mm)). The size of individual strands of a given wire can be in a range of from AWG 24 to AWG 40 (a diameter in a range of from 0.0031 to 0.0201 inches (78.7 to 511 μm)).

Stranded conductor can be manufactured in a variety of configurations, the most common being concentric (true concentric, equilay concentric, unidirectional concentric, and unilay concentric), bunched and rope, wherein concentric is defined as a central strand surrounded by one or more layers of helically strands laid in a geometric pattern. The geometric pattern requires that concentric constructions can only be produced with 7, 19, 37, 61, (etc.) strands or members, following the pattern that each successive layer has 6 more strands than the layer below it. In all types of concentric constructions, the geometric pattern of the strands is consistent for the entire length of the conductor. That is, the central strand, and the strands in each layer remain in their respective positions from the beginning to the end of its length. In one embodiment, a concentric stranded conductor is used.

### Organic Solvents

Useful organic solvents for the synthesis of the polymers of the present invention are preferably capable of dissolving the polymer precursor materials. Such a solvent should also have a relatively low boiling point, such as below 225° C., so the polymer can be dried at moderate (i.e., more convenient and less costly) temperatures. A boiling point of less than 210, 205, 200, 195, 190, or 180° C. is preferred.

Useful organic solvents include: N-methylpyrrolidone (NMP), N,N-dimethylacetamide (DMAc), methyl ethyl ketone (MEK), N,N-dimethyl-formamide (DMF), dimethyl sulfoxide (DMSO), tetramethyl urea (TMU), glycol ethyl ether, diethyleneglycol diethyl ether, 1,2-dimethoxyethane (monoglyme), diethylene glycol dimethyl ether (diglyme), 1,2-bis-(2-methoxyethoxy) ethane (triglyme), gamma-butyrolactone, and bis-(2-methoxyethyl) ether, tetrahydrofuran (THF), ethyl acetate, hydroxyethyl acetate glycol monoacetate, acetone and mixtures thereof. In one embodiment, preferred solvents include N-methylpyrrolidone (NMP) and N,N-dimethylacetamide (DMAc).

### Diamines

In one embodiment, any number of suitable diamines can be used for monomers to form the polymer backbone. Aromatic diamines can include fluorinated aromatic diamines, such as 2,2′-bis(trifluoromethyl)benzidine (TFMB), 2,2′-bis-(4-aminophenyl) hexafluoropropane, 4,4′-diamino-2,2′-trifluoromethyldiphenyloxide, 3,3′-diamino-5,5′-trifluoromethyldiphenyloxide, 9,9′-bis(4-aminophenyl) fluorene, 4,4′-trifluoromethyl-2,2′-diaminobiphenyl, 4,4′-oxy-bis[2-trifluoromethyl)benzeneamine](1,2,4-OBABTF), 4,4′-oxy-bis[3-trifluoromethyl)benzeneamine], 4,4′-thiobis[(2-trifluoromethyl)benzeneamine], 4,4′-thiobis[(3-trifluoromethyl)benzeneamine], 4,4′-sulfoxyl-bis[(2-trifluoromethyl)benzeneamine, 4,4′-sulfoxyl-bis[(3-trifluoromethyl)benzeneamine], 4,4′-keto-bis[(2-trifluoromethyl)benzeneamine], 1,1-bis[4′-(4″-amino-2″-trifluoromethylphenoxy)phenyl]cyclopentane, 1,1-bis[4′-(4″-amino-2″-trifluoromethylphenoxy)phenyl]cyclohexane, 2-trifluoromethyl-4,4′-diaminodiphenylether; 1,4-(2′-trifluoromethyl-4′,4″-diaminodiphenoxy)benzene, 1,4-bis(4′-aminophenoxy)-2-[(3′,5′-ditrifluoromethyl)phenyl]benzene (6F-amine), 1,4-bis[2′-cyano-3′(″4-amino phenoxy) phenoxy]-2-[(3′,5′-ditrifluoro-methyl)phenyl]benzene (6FC-diamine), 3,5-diamino-4-methyl-2′,3′,5′,6′-tetrafluoro-4′-tri-fluoromethyldiphenyloxide, 2,2-bis[4 (4-aminophenoxy)phenyl]phthalein-3′,5′-bis(trifluoromethyl) anilide (6FADAP) and 3,3′,5,5′-tetrafluoro-4,4′-diamino-diphenylmethane (TFDAM).

Other useful aromatic diamines can include 4,4′-diaminobiphenyl, 4,4”-diaminoterphenyl, 4,4′-diaminobenzanilide (DABA), 4,4′-diaminophenylbenzoate, 4,4′-diaminobenzophenone, 4,4′-diaminodiphenylmethane (MDA), 4,4′-diaminodiphenylsulfide, 4,4′-diaminodiphenylsulfone, 3,3′-diaminodiphenylsulfone, bis[4-(4-aminophenoxy)phenyl]sulfone (BAPS), 4,4′-bis(4-aminophenoxy) biphenyl (BAPB), 4,4′-diaminodiphenylether (ODA), 3,4′-diaminodiphenylether, 4,4′-isopropylidenedianiline, 2,2′-bis(3-aminophenyl) propane, 2,2-bis(4-aminophenyl) propane, 3,3′-dimethyl-4,4′-diaminobiphenyl, 4-aminophenyl-3-aminobenzoate, bis(p-beta-amino-t-butylphenyl) ether, p-bis-2-(2-methyl-4-aminopentyl)benzene. In one embodiment, the diamine is a triamine, such as N,N-bis(4-aminophenyl)-n-butylamine, N,N-bis(4-aminophenyl)methylamine or N, N-bis(4-aminophenyl) aniline.

Other useful aromatic diamines can include 1,2-bis(4-aminophenoxy)benzene, 1,3-bis(4-aminophenoxy)benzene (RODA), 1,2-bis(3-aminophenoxy)benzene, 1,3-bis(3-aminophenoxy)benzene, 1-(4-aminophenoxy)-3-(3-aminophenoxy)benzene, 1,4-bis-(4-aminophenoxy)benzene, 1,4-bis(3-aminophenoxy)benzene, 1-(4-aminophenoxy)-4-(3-aminophenoxy)benzene, 2,2-bis(4-[4-aminophenoxy]phenyl) propane (BAPP), 2,2′-bis(4-phenoxyaniline) isopropylidene.

Other useful aromatic diamines can include p-phenylenediamine (PPD), m-phenylenediamine (MPD), 2,5-dimethyl-1,4-diaminobenzene, 2,5-dimethyl-1,4-phenylenediamine (DPX), 1,4-naphthalenediamine, 1,5-naphthalenediamine, 1,5-diaminonaphthalene, m-xylylenediamine, and p-xylylenediamine.

In one embodiment, additional useful diamines for forming the polyimide can include an aliphatic diamine, such as 1,2-diaminoethane, 1,6-diaminohexane (HMD), 1,4-diaminobutane, 1,5 diaminopentane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, trans-1,4-diaminocyclohexane (CHDA), isophoronediamine (IPDA), bicyclo[2.2.2]octane-1,4-diamine and combinations thereof. Other aliphatic diamines suitable for practicing the invention include those having six to twelve carbon atoms or a combination of longer chain and shorter chain diamines so long as both developability and flexibility of the polymer are maintained. Long chain aliphatic diamines may increase flexibility.

Other useful additional diamines for forming the polymer can include an alicyclic diamine (can be fully or partially saturated), such as a cyclobutane diamine (e.g., cis- and trans-1,3-diaminocyclobutane, 6-amino-3-azaspiro[3.3]heptane, and 3,6-diaminospiro[3.3]heptane), bicyclo[2.2.1]heptane-1,4-diamine, isophoronediamine, and bicyclo[2.2.2]octane-1,4-diamine. Other alicyclic diamines can include cis-1,4-cyclohexanediamine, trans-1,4-cyclohexanediamine, 1,4-bis(aminomethyl)cyclohexane, 4,4′-methylenebis(cyclohexylamine), 4,4′-methylenebis(2-methyl-cyclohexylamine), bis(aminomethyl) norbornane.

In one embodiment, a polyimide is derived from predominantly 4,4′-diaminodiphenylether (ODA) or its isomers, 1,3-bis(4-aminophenoxy)benzene (RODA), and 1,6-diaminohexane (HMD).

### Dianhydrides

In one embodiment, any number of suitable dianhydrides can be used for monomers to form the polymer backbone. The dianhydrides can be used in their tetra-acid form (or as mono, di, tri, or tetra esters of the tetra acid), or as their diester acid halides (chlorides). However, in some embodiments, the dianhydride form can be preferred, because it is generally more reactive than the acid or the ester.

Examples of suitable aromatic dianhydrides include 3,3′,4,4′-biphenyltetracarboxylic dianhydride (BPDA), 2-(3′,4′-dicarboxyphenyl)-5,6-dicarboxybenzimidazole dianhydride, 2-(3′,4′-dicarboxyphenyl)-5,6-dicarboxybenzoxazole dianhydride, 2-(3′,4′-dicarboxyphenyl)-5,6-dicarboxybenzothiazole dianhydride, 2,2′,3,3′-benzophenonetetracarboxylic dianhydride, 2,3,3′,4′-benzophenonetetracarboxylic dianhydride, 3,3′,4,4′-benzophenonetetracarboxylic dianhydride (BTDA), 2,2′,3,3′-biphenyltetracarboxylic dianhydride, 2,3,3′,4′-biphenyltetracarboxylic dianhydride, 4,4′-thio-diphthalic anhydride, bis(3,4-dicarboxyphenyl) sulfone dianhydride, bis(3,4-dicarboxyphenyl) sulfoxide dianhydride (DSDA), bis(3,4-dicarboxyphenyloxadiazole-1,3,4)-p-phenylene dianhydride, bis(3,4-dicarboxyphenyl)-2,5-oxadiazole-1,3,4-dianhydride, bis(3′,4′-dicarboxydiphenylether)-2,5-oxadiazole-1,3,4-dianhydride, 4,4′-oxydiphthalic anhydride (ODPA), bis(3,4-dicarboxyphenyl)thioether dianhydride, bisphenol A dianhydride (BPADA), bisphenol S dianhydride, bis-1,3-isobenzofurandione, 1,4-bis(4,4′-oxyphthalic anhydride)benzene, bis(3,4-dicarboxyphenyl) methane dianhydride, perylene-3,4,9,10-tetracarboxylic dianhydride, 1,3-bis-(4,4′-oxydiphthalic anhydride)benzene, 2,2-bis(3,4-dicarboxyphenyl) propane dianhydride, 4,4′-(hexafluoroisopropylidene)diphthalic anhydride (6FDA) and 9,9-bis(trifluoromethyl)-2,3,6,7-xanthenetetracarboxylic dianhydride.

In one embodiment, additional dianhydrides for forming the polymer can include 1,2,5,6-naphthalenetetracarboxylic dianhydride, 1,4,5,8-naphthalenetetracarboxylic dianhydride, 2,3,6,7-naphthalenetetracarboxylic dianhydride, bicyclo-[2,2,2]-octen-(7)-2,3,5,6-tetracarboxylic-2,3,5,6-dianhydride, cyclopentadienyltetracarboxylic dianhydride, ethylenetetracarboxylic dianhydride, pyromellitic dianhydride (PMDA), tetrahydrofurantetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride and thiophene-2,3,4,5-tetracarboxylic dianhydride.

In one embodiment, additional dianhydrides for forming the polyimide can include an alicyclic dianhydride, such as cyclobutane-1,2,3,4-tetracarboxylic diandydride (CBDA), 1,2,4,5-cyclohexanetetracarboxylic dianhydride, 1,2,3,4-cyclohexanetetracarboxylic dianhydride, 1,2,3,4-tetramethyl-1,2,3,4-cyclobutanetetracarboxylic dianhydride, 1,2,3,4-cyclopentanetetracarboxylic dianhydride (CPDA), hexahydro-4,8-ethano-1H,3H-benzo[1,2-c: 4,5-c′]difuran-1,3,5,7-tetrone (BODA), 3-(carboxymethyl)-1,2,4-cyclopentanetricarboxylic 1,4:2,3-dianhydride (TCA), and meso-butane-1,2,3,4-tetracarboxylic dianhydride.

In one embodiment, a polyimide is derived from predominantly pyromellitic dianhydride (PMDA), 3,3′,4,4′-biphenyltetracarboxylic dianhydride (BPDA), and 4,4′-oxydiphthalic anhydride (ODPA). In one embodiment a polyimide can have a weight-average molecular weight (Mw) of 100,000 daltons or more, 150,000 daltons or more, 200,000 daltons or more, or 250,000 daltons or more.

### Imidization Catalysts

In one embodiment, an imidization catalyst (sometimes called an “imidization accelerator”) can be used as a conversion chemical that can help lower the imidization temperature for forming a polyimide and shorten the imidization time. The polyamic acid casting solutions of the present invention comprises both a polyamic acid solution combined with some amount of conversion chemicals. The conversion chemicals found to be useful in the present invention include, but are not limited to, (i) one or more dehydrating agents and/or co-catalysts, such as, aliphatic acid anhydrides (acetic anhydride, trifluoroacetic anhydride, propionic anhydride, monochloroacetic anhydride, bromo adipic anhydride, etc.) and aromatic acid anhydrides; and (ii) one or more imidization catalysts, such as, aliphatic tertiary amines (triethylamine, etc.), aromatic tertiary amines (dimethylaniline, N,N-dimethyl benzylamine, etc.) and heterocyclic tertiary amines (pyridine, alpha-, beta-, gamma-picoline, 3,5-lutidine, 3,4-lutidene, isoquinoilne, etc.) and guanidines (e.g. tetramethylguanidine). In one embodiment, an imidization catalyst does not include a diazole. Other useful dehydrating agents can include diacetyl oxide, butyryl oxide, benzoyl oxide, 1,3-dichlorohexyl carbodiimide, N, N-dicyclohexyl carbodiimide, benzenesulfonyl chloride, thionyl chloride and phosphorus pentachloride. In some embodiments, the dehydrating agent can also act as a catalyst to enhance the reaction kinetics for the imidization. The anhydride dehydrating material is typically used in a slight molar excess of the amount of amide acid groups present in the polyamic acid solution. In one embodiment, the amount of dehydrating agent used is typically about 2.0 to 4.0 moles per equivalent of the polyamic acid formula unit. Generally, a comparable amount of tertiary amine catalyst is used. The ratio of these catalysts and their concentration in the polyamic acid solution will influence imidization kinetics and the film properties. Polyimide films having substantially chemically converted polyimide can have imidization catalysts present in the polyimide film in an amount in the range of from 1 part per billion (ppb) to 1 wt %, from 10 ppb to 0.1 wt %, or from 100 ppb to 0.01 wt %.

### Corona Resistant Composite Fillers

The polymer film of the present disclosure comprises an electrically insulative, corona resistant composite filler. In one embodiment, a corona resistant composite filler can have an organic component and an inorganic ceramic oxide component, wherein a weight ratio of the organic component to the inorganic ceramic oxide component is from 0.01:1 to 1:1. In some embodiments, the weight ratio of the organic component to the inorganic ceramic oxide component can be in a range between (and optionally including) any two of the following numbers: 0.01:1, 0.05:1, 0.1:1, 0.2:1, 0.3:1, 0.4:1, 0.5:1, 0.6:1, 0.7:1, 0.8:1, 0.9:1 and 1:1. In one embodiment, at least a portion of the organic component can include an organo-siloxane moiety or an organo-metaloxane moiety (e.g., organozirconate, organotitanate, organoaluminate).

In one embodiment, the inorganic ceramic oxide component can include ceramic oxides of Al, V, Cr, Mn, Fe, Co, Ni, Cu, Zn, Ge, Zr, Nb, Mo, Sn, Sb, Ta, W, Pb, Ce and mixture thereof. In exemplary embodiments, the inorganic ceramic oxide component can include silica, alumina, titania, zirconia, iron, calcium or mixtures thereof. In one embodiment, the inorganic ceramic oxide component includes silica, alumina or a mixture thereof. In one embodiment, the inorganic ceramic oxide component is alumina.

In one embodiment, the electrically insulative, corona resistant composite filler is an inorganic nitride such as boron nitride, alumina nitride, gallium nitride, titanium nitride, silicon nitride, and mixture thereof.

In one embodiment, the organic component of the corona resistant composite filler material is chosen primarily to provide or improve dispersability of the corona resistant composite filler material into a particular solvated polymer matrix or polymer matrix precursor. In some embodiments, the organic component of the corona resistant composite filler material is chosen to reduce the moisture absorption on the inorganic ceramic oxide component. Ordinary skill and experimentation may be necessary in optimizing the organic component for any particular solvent system selected. In some embodiments, the organo-siloxane moiety is n-octyl silane, or any of its structural isomers. In some embodiments, the corona resistant composite filler is an inorganic ceramic oxide without an organic component. In another embodiment, the organic component is a coating on the inorganic ceramic oxide component. The organic component may or may not cover the entire surface of the inorganic ceramic oxide component.

In one embodiment, the electrically insulative, corona resistant composite filler is present in an amount between and including any two of the following numbers: 5, 10, 15, 20, 25 and 30 weight percent, based upon the total weight of the polyimide film. In one embodiment, the corona resistant composite filler is present in an amount in a range of from 5 to 30, 5 to 25 or 5 to 20 weight percent, based upon the total weight of the polyimide film. In one embodiment, the filler content of the polyimide film is determined using ASTM D5630.

In one embodiment, the corona resistant composite filler can have a median particle size of from 0.1 to 5 μm, wherein at least 80, 85, 90, 92, 94, 95, 96, 98, 99 or 100 percent of the dispersed corona resistant composite filler is within the above defined size range. In an example embodiment, the particle size distribution of the filler is a d99 of 1 μm or less, or 0.5 μm or less. Median particle size can be measured using a Horiba LA-930 particle size analyzer (Horiba Instruments, Inc., Irvine, CA). DMAc can be used as the carrier fluid. In some embodiments, the corona resistant composite filler is a nanofiller. The term “nanofiller” is intended to mean a filler with at least one dimension less than 1000 nm, i.e., less than 1 μm.

In one embodiment, the polymer film additionally includes a dispersing agent. In some embodiments, a polyimide film additionally includes a dispersing agent in an amount in a range of from 1 to 100 weight percent based on the weight of the inorganic ceramic oxide component. In some embodiments, the dispersing agent is selected from the group consisting of phosphated polyethers, phosphated polyesters, and mixtures thereof. In another embodiment, the dispersing agent is an alkylolammonium salt of a polyglycol ester. In another embodiment, the dispersing agent is selected from the group consisting of Disperbyk 180, an alkylolammonium salt of a polyglycol ester, Disperbyk 111, a phosphated polyester, Byk W-9010, a phosphated polyester or mixtures there of (all available from Byk-Chemie GmBH, Wesel, Germany). In another embodiment, the dispersing agent is Solplus D540, a phosphated ethylene oxide/propylene oxide copolymer available from Lubrizol, Inc., Cleveland, OH. In yet another embodiment, the dispersing agent is a mixture of any of the above dispersing agents. In some embodiments, the dispersing agent is an aromatic polyamic acid or aromatic polyimide. In another embodiment the dispersing agent is a polyalkylene ether such as polytetramethylene glycol and polyethylene glycol. Typically, aromatic polyamic acid or aromatic polyimide have high temperature stability and thus mostly would remain in the polyimide. Whereas dispersing agents such as polyalkylene ethers have a low temperature stability and would mostly decompose or be burned off at the temperatures used in the imidization process.

In cases where the insulative material is a multilayer polyimide film, filler may be present in one or more of the layers. The nature of the filler in each layer may be selected independently. In one embodiment, the insulative material is a two-layer polyimide film consisting of a polyimide core layer and a thermoplastic polyimide layer, and only one of the layers contains a filler. In another embodiment, the insulative material is a three-layer polyimide film consisting of a polyimide core layer and two outer thermoplastic polyimide layers, and only the core layer contains a filler. In another embodiment, the insulative material is a three-layer polyimide film consisting of a polyimide core layer and two outer thermoplastic polyimide layers, and only the outer layers contain a filler.

The presence of filler in the outermost layers in the case of a multilayer polyimide film may affect the final properties of the film such as adhesion to a metal surface, voltage endurance properties, and residual solvent content in the multilayer film.

### Base Film Tapes

In one embodiment, a base film tape includes a polymer core layer and at least a first thermoplastic polymer outer layer adhered to a first side of the polymer core layer. In one embodiment, the base film tape includes a second thermoplastic polymer outer layer adhered to a second side of the polymer core layer. In one embodiment, a base film tape includes one or more thermoplastic polymer layers. In one embodiment the base film tape can be used as an insulating wrap for an electrically insulated conductor. In one embodiment, the polymer core can include a polyimide (PI), a poly(amide-imide) (PAI), a polyaryletherketone (PAEK), a polyphenylene sulfide (PPS), a polyphenylene sulfone (PPSU), a polyether sulfone (PES), a polyetherimide (PEI), or a mixture thereof.

In one embodiment, a polyimide film for the polymer core layer or a thermoplastic (outer) layer can be produced by combining a diamine and a dianhydride (monomer or other polyimide precursor form) together with a solvent to form a polyamic acid (also called a polyamide acid) solution. The dianhydride and diamine can be combined in a molar ratio of about 0.90 to 1.10. The molecular weight of the polyamic acid formed therefrom can be adjusted by adjusting the molar ratio of the dianhydride and diamine.

In one embodiment, a polyamic acid casting solution is derived from the polyamic acid solution. The polyamic acid casting solution, and/or the polyamic acid solution, are combined with conversion chemicals like: (i) one or more dehydrating agents, such as, aliphatic acid anhydrides (acetic anhydride, etc.) and/or aromatic acid anhydrides; and (ii) one or more catalysts, such as, aliphatic tertiary amines (triethyl amine, etc.), aromatic tertiary amines (dimethyl aniline, etc.) and heterocyclic tertiary amines (pyridine, picoline, isoquinoline, etc.). The anhydride dehydrating material it is often used in molar excess compared to the amount of amide acid groups in the polyamic acid. The amount of acetic anhydride used is typically about 2.0 to 4.0 moles per equivalent (repeat unit) of polyamic acid. Generally, a comparable amount of tertiary amine catalyst is used. Fillers, dispersed or suspended in solvent as described above, are then added to the polyamic acid solution.

In one embodiment, the polyamic acid solution is dissolved in an organic solvent at a concentration from about 5.0 or 10 percent to 15, 20, 25, 30, 35 or 40 percent by weight. In one embodiment, a slurry comprising a filler is prepared, where the slurry has a solids content in a range of from 0.1 to 70, from 0.5 to 60, from 1 to 55, from 5 to 50, or from 10 to 45 percent by weight. The slurries may or may not be milled using a ball mill to reach the desired particle size. The slurries may or may not be filtered to remove any residual large particles. A polyamic acid solution can be made by methods well known in the art. The polyamic acid solution may or may not be filtered. In some embodiments, the solution is mixed in a high shear mixer with the filler slurry. When a polyamic acid solution is made with a slight excess of diamine, additional dianhydride solution may or may not be added to increase the viscosity of the mixture to the desired level for film casting. The amount of the polyamic acid solution, and filler slurry can be adjusted to achieve the desired loading levels in the cured film. In some embodiments, the mixture is cooled below 10° C. and mixed with conversion chemicals prior to casting.

The solvated mixture (the polyamic acid casting solution) can then be cast or applied onto a support, such as an endless belt or rotating drum, to give a partially imidized gel film. Alternatively, it can be cast on a polymeric carrier such as PET, other forms of Kapton® polyimide film (e.g., Kapton@ HN or Kapton® E films) or other polymeric carriers. The gel film may be stripped from the drum or belt, placed on a tenter frame, and cured in an oven, using convective and radiant heat to remove solvent and complete the imidization to greater than 98% solids level. The film can then be separated from the support, oriented such as by tentering, with continued heating (drying and curing) to provide a substantially chemically converted polyimide film.

Useful methods for producing polyimide films can be found in U.S. Pat. Nos. 5,166,308 and 5,298,331, which are incorporate by reference into this specification for all teachings therein. Numerous variations are also possible, such as,
(a) A method wherein the diamine components and dianhydride components are preliminarily mixed together and then the mixture is added in portions to a solvent while stirring.
(b) A method wherein a solvent is added to a stirring mixture of diamine and dianhydride components. (contrary to (a) above)
(c) A method wherein diamines are exclusively dissolved in a solvent and then dianhydrides are added thereto at such a ratio as allowing to control the reaction rate.
(d) A method wherein the dianhydride components are exclusively dissolved in a solvent and then amine components are added thereto at such a ratio to allow control of the reaction rate.
(e) A method wherein the diamine components and the dianhydride components are separately dissolved in solvents and then these solutions are mixed in a reactor.
(f) A method wherein the polyamic acid with excessive amine component and another polyamic acid with excessive dianhydride component are preliminarily formed and then reacted with each other in a reactor, particularly in such a way as to create a non-random or block copolymer.
(g) A method wherein a specific portion of the amine components and the dianhydride components are first reacted and then the residual diamine components are reacted, or vice versa.
(h) A method wherein the conversion chemicals (catalysts) are mixed with the polyamic acid to form a polyamic acid casting solution and then cast to form a gel film.
(i) A method wherein the components are added in part or in whole in any order to either part or whole of the solvent, also where part or all of any component can be added as a solution in part or all of the solvent.
(j) A method of first reacting one of the dianhydride components with one of the diamine components giving a first polyamic acid. Then reacting another dianhydride component with another amine component to give a second polyamic acid. Then combining the amic acids in any one of a number of ways prior to film formation.

In one embodiment, filler is first dispersed in a solvent to form a slurry. The slurry is then dispersed in the polyamic acid solution. In one embodiment, the concentration of filler to polyimide (in the final film) is in a range of from 10 to 50 vol %, from 15 to 45 vol %, from 15 to 40 vol %, from 20 to 35 vol %, or from 25 to 30 vol %. In one embodiment, the concentration of filler to polyimide (in the final film) is at least 10, at least 15, at least 20, or at least 25 vol %. The composition of the cured film can be calculated from the composition of the components in the mixtures, excluding DMAc solvent (which is removed during curing) and accounting for removal of water during conversion of polyamic acid to polyimide.

In one embodiment, the filled polyamic acid casting solution is a blend of a polyamic acid solution and filler. In this casting solution, the filler is present in a concentration range from 0.1 to 70 vol %, from 1 to 60 vol %, from 2 to 50 vol %, from 5 to 45 vol %, or from 5 to 40 vol %. In one embodiment, the filler is first dispersed in the same polar aprotic solvent used to make the polyamic acid solution (e.g., DMAc). Optionally, a small amount of polyamic acid solution may be added to the filler slurry to increase the viscosity of the slurry. Optionally, a dispersant or dispersing agent may be added to aid in dispersion or alter the rheology of the slurry.

The filler may be blended into a particular solvated polymer matrix or polymer matrix precursor by using any commonly used technique such as batch mixing using solvent(s), dry mixing, or continuous mixing using solvent(s). Parameters such as order of raw material addition, mixing speed, shear rate, type of mixing blade (e.g., shear blade), mixing time, temperature, and pressure are known to affect the final degree of mixing between the filler and the matrix material.

In one embodiment, blending of the filler slurry with a polyamic acid solution to form the filled polyamic acid casting solution is done using high shear mixing. In this embodiment, if the filler is present beyond 50 volume percent in the final film, the film can be too brittle and may not be sufficiently flexible to form a freestanding, mechanically tough, flexible sheet.

In one embodiment, the casting solution can further comprise any one of a number of additives, such as processing aids (e.g., oligomers), antioxidants, light stabilizers, flame retardant additives, anti-static agents, heat stabilizers, ultraviolet absorbing agents or various reinforcing agents.

In some embodiments, a coextrusion process can be used to form a multilayer polyimide film with an inner core layer sandwiched between two outer layers. In this process, a finished polyamic acid solution is filtered and pumped to a slot die, where the flow is divided in such a manner as to form the first outer layer and the second outer layer of a three-layer coextruded film. In some embodiments, a second stream of polyimide is filtered, then pumped to a casting die, in such a manner as to form the middle polyimide core layer of a three-layer coextruded film. The flow rates of the solutions can be adjusted to achieve the desired layer thickness. In one embodiment, strong adhesion between layers can be achieved using coextrusion. In another embodiment, stronger adhesion between layers in a multilayer polyimide film can be achieved using coextrusion when compared to a coating approach in which a thermoplastic polyamic acid solution is coated onto a polyimide core film (already imidized) and subsequently cured. In another embodiment, stronger adhesion between layers in a multilayer polyimide film can be achieved using coextrusion when compared to a lamination approach in which a thermoplastic polyimide film is laminated onto a polyimide core film.

In some embodiments, the multilayer film is prepared by simultaneously extruding the first thermoplastic outer layer, the core layer and the second thermoplastic outer layer. In some embodiments, the layers are extruded through a single or multi-cavity extrusion die. In another embodiment, the multilayer film is produced using a single-cavity die. If a single-cavity die is used, the laminar flow of the streams should be of high enough viscosity to prevent comingling of the streams and to provide even layering. In some embodiments, the multilayer film is prepared by casting from the slot die onto a moving stainless-steel belt. In one embodiment, the belt is then passed through a convective oven, to evaporate solvent and partially imidize the polymer, to produce a “green” film. The green film can be stripped off the casting belt and wound up. The green film can then be passed through a tenter oven to produce a fully cured polyimide film. In some embodiments, during tentering, shrinkage can be minimized by constraining the film along the edges (i.e., using clips or pins).

In one embodiment, the outer layers of a multilayer film can also be applied to the core layer during an intermediate manufacturing stage of making polyimide film such as to gel film or to green film.

When forming a polyimide film, the term “gel film” refers to a polyamic acid sheet, which is laden with volatiles, primarily solvent, to such an extent that the polyamic acid is in a gel-swollen, or rubbery condition, and may be formed in a chemical conversion process. The volatile content is usually in the range of 70 to 90% by weight and the polymer content usually in the range of 10 to 30% by weight of the gel film. The final film becomes “self-supporting” in the gel film stage. It can be stripped from the support on which it was cast and heated to a final curing temperature. The gel film generally has an amic acid to imide ratio between 10:90 and 50:50, most often 30:70.

The gel film structure can be prepared by the method described in U.S. Pat. No. 3,410,826. This patent discloses mixing a chemical converting agent and a catalyst, such as a lower fatty acid anhydride and a tertiary amine, into the polyamic-acid solution at a low temperature. This is followed by casting the polyamic-acid solution in film-form, onto a casting drum. The film is mildly heated after casting, at for example 100° C., to activate the conversion agent and catalyst in order to transform the cast film to a polyamic acid/polyimide gel film.

Another type of polymer film is a “green film” which, for a polyimide film, is partially polyamic acid and partially polyimide, and may be formed in a thermal conversion process. Green film contains generally about 50 to 75% by weight polymer and 25 to 50% by weight solvent. Generally, it should be sufficiently strong to be substantially self-supporting. Green film can be prepared by casting the polyamic acid solution into film form onto a suitable support such as a casting drum or belt and removing the solvent by mild heating at up to 150° C. A low proportion of amic acid units in the polymer, e.g., up to 25%, may be converted to imide units.

Application of the polymer films of the present invention can be accomplished in any number of ways. Such methods include using a slot die, dip coating, or kiss-roll coating a film followed by metering with doctor knife, doctor rolls, squeeze rolls, or an air knife. The coating may also be applied by brushing or spraying. By using such techniques, it is possible to prepare both one and two-sided coated laminates. In preparation of the two-side coated structures, one can apply the coatings to the two sides of a polymer either simultaneously or consecutively before going to the curing and drying stage of the polymer.

The electrically insulative, corona resistant composite filler (dispersion or colloid thereof) can be added at several points in the polyimide film preparation. In one embodiment, the colloid or dispersion is incorporated into a prepolymer having a Brookfield solution viscosity in the range of about 50-100 poise at 25° C. “Prepolymer” is intended to mean a lower molecular weight polymer, typically made with a small stoichiometric excess (about 2-4%) of diamine monomer (or excess dianhydride monomer). In an alternative embodiment, the colloid or dispersion can be combined with the monomers directly, and in this case, polymerization occurs with the filler present during the reaction. In another embodiment, the colloid or dispersion can be combined with the “finished”, high viscosity polyimide. The monomers may have an excess of either monomer (diamine or dianhydride) during this “in situ” polymerization. The monomers may also be added in a 1:1 ratio. In the case where the monomers are added with either the amine (case i) or the dianhydride (case ii) in excess, increasing the molecular weight (and solution viscosity) can be accomplished, if necessary, by adding incremental amounts of additional dianhydride (case i) or diamine (case ii) to approach the 1:1 stoichiometric ratio of dianhydride to amine.

The thickness of the base film tape may be adjusted, depending on the intended purpose of the film or final application specifications. In one embodiment, the base film tape has a total thickness in a range of from 14 to 95 μm, from 14 to 80 μm, from 16 to 65 μm, from 18 to 50 μm, or from 20 to 50 μm. In one embodiment, the polymer core layer has a thickness in a range of from 12 μm to 75 μm, from 12 to 50 μm, or from 12 to 25 μm. In one embodiment, each of the first and the second (when present) thermoplastic outer layers has a thickness in a range of from 1 μm to 10 μm, from 1 to 8 μm, or from 1 to 6 μm. In one embodiment, the thicknesses of the first and the second thermoplastic outer layers may be the same or different, for example one layer may be thicker by 3 μm, 4 μm, or 5 μm than the other layer.

In one embodiment, both the polymer core layer, the first thermoplastic polymer outer layer and the second thermoplastic polymer outer layer each have a T_{g} of 200° C. or higher, 205° C. or higher, 210° C. or higher, 215° C. or higher, 220° C. or higher or 225° C. or higher. In one embodiment, both the polymer core layer, the first thermoplastic polymer outer layer and the second thermoplastic polymer outer layer each have a T_{g} in a range of from 200 to 250° C., from 205 to 245° C., from 210 to 240° C. or from 215 to 235° C. In one embodiment, the T_{g} of the polymer core layer is higher than the T_{g} of the thermoplastic polymer outer layer(s) by at least 50° C., 70° C., 100° C., or 120° C. In one embodiment, a ratio of a bending radius (R) to a width (W) of the insulated conductor is in a range of from 0.8:1 to 2:1, from 1:1 to 2:1, from 1.2:1 to 1.9:1 or from 1.4:1 to 1.9:1. In one embodiment, the base film tape has a G_{lc} of the first thermoplastic polymer outer layer to the conductive core is 200 J/m² or more. In one embodiment, an average ultimate strain for the polymer core layer and the first thermoplastic polymer outer layer each are 60% or more. In one embodiment, a ratio of a tensile modulus of the first thermoplastic polymer outer layer to a tensile modulus of the polymer core layer is 0.7:1 or more. In one embodiment, the polyimide film may have other desirable properties, such as: (a) a dielectric strength of 3 kV/mil or greater (for example as determined using ASTM D149), (b) a thermal rating of 200° C. or greater, (c) a residual volatile content (excluding water) of less than 1 wt %, and/or (d) an improved voltage endurance lifetime under AC, DC, or pulse-width modulated conditions when compared to a non-filled insulation applied at the same thickness (for example as determined using ASTM D2275). The testing of these properties may occur according to standard procedures known to the industry such as published by ASTM (such as, for example, D2305) or UL.

### Adhesion Promoter

In one embodiment, a thin layer of an adhesion promoter material may be applied to the conductive element before applying the insulative material. Use of an adhesion promoter can increase the measured G_{lc} between two material layers. In one embodiment the adhesion promoter is applied as a coating solution in form of a solution or a dispersion in a liquid medium or carrier. The liquid medium or carrier may be aqueous and/or organic solvent based, such as, for example, ketones, esters, ethers, aromatic hydrocarbons, aliphatic hydrocarbons, lactones, amides, alcohols, mixtures thereof, or water. The coating solution may be applied as a single coating and dried. However, additional coats can be applied as well. If multiple coatings are applied, a curing step may be performed between each application step.

Application of the coating solution in exemplary embodiments disclosed herein can be accomplished in any number of ways. Such methods include using a die or dip coating, by brushing or spraying.

The non-volatile solid content in the coating solution, once applied to a substrate and dried, may be cured. In this context, “cure” refers to a process that changes the state and/or structure of the non-volatile solid content that is usually, but not necessarily, triggered by a variable such as moisture, temperature, and/or addition of a chemical such as a base, acid, or other catalyst. The curing process may be partial or complete in terms of converting reactive groups contained in the coating solution, such as silanol groups. Conversion of the reactive groups may occur by several reaction mechanisms, which in one embodiment may include a condensation reaction driven by humidity/moisture at ambient temperature. In one embodiment, the dried coating solution is allowed to cure at ambient moisture and ambient temperature over the course of 24 hours or less. In another embodiment, heat is applied to speed up the curing process. Curing times may be shortened by the addition of more moisture or one or more appropriate catalysts, such as an acid, base, or metal-based compound, or mixtures thereof. Several methods may be combined to accelerate the curing process.

The cured release coating may have an average dry coating thickness of less than 1 μm when applied to a conductive element. In one embodiment, the average dry coating thickness is less than 0.5 μm, less than 0.25 μm, or less than 0.1 μm.

The coating solution may include one or more siloxane monomers, oligomers, or polymers. Each siloxane oligomer or polymer may have a branched or linear structure, or elements of both. In one embodiment, the siloxane is a silane or mixture of silanes of the form SiR¹X¹X²X³. Substituent R¹ may be alkyl, or aryl, and bear additional substituents or functional groups such as vinyl, alkoxy, amino, hydroxyl, hydrogen, mercapto, halo, epoxy and cyano. The alkyl group may be selected from a C1-C20 alkyl group, preferably a C1-C8 alkyl group. The aryl group may be selected from a C6-C18 aryl group, preferably a phenyl group. Substituents X may be the same or different and may be selected from amino, acetoxy, alkoxy, alkyl, allyl, hydroxyl, hydrogen, vinyl, enoxy, and oxime functional groups. The alkoxy group may be selected from a C1-C8 alkoxy group, especially a methoxy or ethoxy group. In some embodiments, at least one or more hydroxyl or alkoxy groups is attached directly to a silicon atom.

In one embodiment, the coating solution includes one or more silanes which can react partially or fully to produce crosslinks with themselves or with other silanes that are present and/or the surfaces with which the coating solution comes into contact.

### Electrically Insulated Conductors

In one embodiment, an electrically insulated conductor having an electrically insulative, corona resistant composite filler is useful as a wire wrap. Suitable materials to be wrapped include bare electrical conductors, electrical conductors covered in enamel (such as polyester-imide (PEI), polyamideimide (PAI), PEI/PAI combinations, or polyimide enamel), electrical conductors covered with an extruded resin, or electrical conductors covered with film tape. In some embodiments, the wire wrap may contain additional layers, such as adhesive layers or scrape abrasion resistant layers. Films or sheets of wire wrap can be slit into narrow widths to provide tapes. These tapes can then be wound around an electrical conductor in spiral fashion or in an overlapped fashion or in a longitudinal fashion with or without overlap. The amount of overlap can vary, depending upon the angle of the wrap. In one embodiment, the amount of overlap is 20% or greater, 45% or greater, or 52% or greater. In one embodiment, the amount of overlap does not exceed 70%. The tension employed during the wrapping operation can also vary widely, ranging from just enough tension to prevent wrinkling, to a tension high enough to stretch and neck down the tape. Even when the tension is low, a snug wrap is possible since the tape will often shrink under the influence of heat during any ensuing heat-sealing operation. Heat-sealing of the tape can be accomplished by treating the tape-wrapped conductor at a temperature and time sufficient to fuse the bonding layer to the other layers in the composite. The heat-sealing temperature required ranges generally from 240, 250, 275, 300, 325 or 350° C. to 375, 400, 425, 450, 475 or 500° C., depending upon the insulation thickness, the gauge of the metal conductor, the speed of the production line and the length of the sealing. Parameters, such as absolute humidity level and temperature of the surrounding atmosphere, line tension, wrap angle, heating and cooling rates, as well as the means by which the heat (e.g., convective, radiant, or induction) and pressure are applied can influence the performance of the final wire insulation material.

One benefit of using a corona-resistant insulating film on a conductor is that the resulting construction has a significantly thinner overall diameter compared to similarly performing solutions that use a non-corona-resistant insulating film, which overall enables savings in both occupied space and weight in any given application.

The wrapped electrical conductor may have certain desirable properties. Desired properties include: (a) a thermal class rating of 200° C. or greater when applied on copper conductor, (b) a residual solvent content of 1 wt % or less, (c) a breakdown voltage value of 2 kV or more which is retained to at least 50% of the initial value after: (i) elongation of the wrapped conductor by at least 5%, (ii) bending with an R/W ratio in a range of from 0.8:1 to 2:1, (iii) exposure to chemicals (such as automotive transmission fluids (ATF) or other motor cooling fluids) or (iv) thermal exposure to temperatures of 200° C. or greater, (d) no visual damage when bent edgewise or flatwise by a 180° turn around a mandrel having diameter two times the width of the conductor, (e) no visual damage when exposed to at least 200° C. for at least 30 minutes or when additionally first bent flatwise or edgewise or when additionally first elongated by at least 10%, (f) an elongation to break of at least 30%, (g) a loss of adhesion of the insulation material of less than 1× the width of the conductor after elongation by at least 20% or when additionally first thermally aged for at least 30 minutes at a temperature of at least 150° C., (h) a certain static friction coefficient, (i) a certain partial discharge inception voltage at ambient conditions at a threshold of 20 picocoulomb of 700 V or greater, (j) a certain abrasion/scrape resistance, and (k) a certain degree of concentricity. Concentricity is the measurement of the location of the center of the conductor with respect to the geometric center of the surrounding insulative material. The more uniform the insulative material is in terms of thickness around the conductor, the better the location of the center of the conductor will match the location of the geometric center of the surrounding insulative material. A match in location of these two values as close as possible is preferred. The testing of any of these properties may occur according to standard procedures known to the industry such as IEC 60851, ASTM (e.g., using procedures as described in ASTM D1676), or ANSI/NEMA MW 1000.

The advantageous properties of this invention can be observed by reference to the following examples that illustrate, but do not limit, the invention. All parts and percentages are by weight unless otherwise indicated.

### EXAMPLES

### Test Methods

### Thickness

Film thickness was determined by measuring 5 positions across the profile of the film using a contact-type FISCHERSCOPE MMS PC2 modular measurement system thickness gauge (Fisher Technology Inc., Windsor, CT).

### Glass Transition Temperature

Glass transition temperature (T_{g}) was measured following test method IPC-TM-650 using dynamic mechanical analysis (Q800 DMA, TA Instrument, New Castle, DE). The test specimens were conditioned at 23° C. and 50% relative humidity for not less than 24 hours prior to testing. Heat was applied at a rate of 5° C./min in dry air, and the value of the tan delta peak was recorded.

### Peel Testing on Smooth Copper

Polished 110 copper sheet (4×8×0.08″, McMaster-Carr, Elmhurst, IL) was used for peel testing. The surface roughness was analyzed with a 3D Laser Scanning Confocal Microscope (VK-X260K, Keyence Corp. of America, Itasca, IL). 11 locations were imaged with a 50× objective (287 μm×216 μm FOV). The polished copper sheet had a surface roughness of: Sₐ=21 nm; S_{dr}=0.41%.

Copper sheet samples were first placed in an acetic acid pickling solution (Acetic Acid/deionized water (10/90 v/v) with NaCl (1.75 wt %)) for 30 seconds, thoroughly rinsed with deionized water, and blotted dried with paper towel. Control samples (without adhesion promoter) were used as-is. Adhesion promoter was applied by pipetting excess solution onto the level copper substrates so that the entire surface was covered. After 30 seconds, the copper plate was tilted 90 degrees such that excess solution ran off the surface and onto a paper towel. The copper plate was air-dried in an up-right position for at least 30 minutes under ambient conditions.

Polyimide films were cut into test strips (0.5×8″) using a JDC precision sample cutter (Model JDC 5-10, Thwing-Albert Instrument Co., West Berlin, NJ).

Test samples were assembled as follows: A 1.5×4″ piece of PFA (PerFluoroAlkoxy, 1 mil) film was placed at the top of the copper sheet to prevent adhesion between the test strips and copper (creating a peel arm). Four polyimide test strips (0.5×8″) were equally spaced across the copper sheet. In some cases, the thickness of the test strips was increased by placing a second or third strip on top of the first. A piece of Kapton® tape was applied to the bottom of the samples to hold the multi-layer test strips in place. A sheet of PTFE Teflon® (3 mil) was draped over the film strips. Samples were sandwiched between Pacopad™ high temperature Thermopads™, which were placed inside 12×12″ mirror polished stainless-steel plates lined with 12×12″ Kapton® HN film.

Lamination of film samples was performed by loading the assembled test samples into a vacuum press (Model 1553/10/17/32755/HELC, OEM Press Systems Inc., Fullerton, CA) with the platens pre-heated to 120° C. Vacuum was applied for 10 minutes, 500 lbs of force was applied, and the test samples were heated to a final temperature and pressure (typically 310° C., 16,000 lbs (500 psi) for 1 hour, unless otherwise noted). Samples were cooled to room temperature under pressure.

Peel testing was performed in accordance with ASTM D6862-11.

### Double Cantilever Beam Testing

Polyimide films were cut into test strips (0.5″) using the JDC precision sample cutter. For measuring adhesion to aluminum, test strips were cut to 3″ in length and situated on 0.125×0.5×4″ 6061 aluminum beams such that a 1″ gap remained on one side of the beam. A second aluminum beam was placed over the film and Kapton® tape was wrapped around the sandwich structure (at both ends) to keep the layers aligned.

Samples were situated in-between PTFE Teflon® (3 mil) inside Pacopad™ high temperature Thermopads™, which were placed inside 12×12″ mirror polished stainless-steel plate lined with 12×12″ Kapton® HN film. Samples were loaded into the vacuum press with the platens pre-heated to 120° C. Vacuum was applied for 10 minutes, 500 lbs of force was applied, and the samples were heated to a final temperature and pressure for 1 hour before cooling to room temperature under pressure.

Interlaminar Fracture Toughness in Mode I (G_{lc}) was measured in accordance with the method described in B. R. K. Blackman and A. J. Kinloch, “Fracture Tests for Structural Adhesive Joints”, in “Fracture Mechanics Testing Methods for Polymers, Adhesives and Composites”, Eds. A. Pavan, D. R. Moore and J. G. Williams, (Elsevier Science, Amsterdam), 2001. For samples that did not peel apart at the interface of the laminated layers, the G_{lc} value is reported as greater than 700 J/m² and the interface is no longer considered an interface that can experience adhesive failure.

### T-Peel Testing

Films samples were cut to 3×6″ and stacked with a 1×3″ piece of PFA (1 mil) in between the top of the sample to create a peel arm. Samples were laminated using the conditions described above for Peel Testing on Smooth Copper.

### Comparative Example 1

For Comparative Example 1 (CE1), a first polyamic acid solution “A” of a monomer composition ODPA (4,4′-oxydiphthalic anhydride)/PMDA (pyromellitic dianhydride) (in a molar ratio of 4:1) and 1,3-bis(4-aminophenoxy)benzene (RODA) was prepared by dissolving the diamine in DMAc with a mechanical stirrer under nitrogen, followed by the addition of the dianhydride powders over a short period of time until a molar stoichiometry of approximately 1:0.97 between amines and anhydride monomers is obtained. The polyamic acid solution was then finished by incrementally adding a 6 wt % solution of PMDA in DMAc to obtain a maximum viscosity of 2500-3000 poise. A second polyamic acid solution “B” of a monomer composition of BPDA 0.35/PMDA 0.65//PPD 0.13/ODA 0.87 was prepared by following the procedure as described above. Both polyamic acid solutions were co-cast on a stainless-steel belt and then dried and imidized by heating in an oven. A polyimide tri-layer A-B-A film of an overall thickness of ˜50 μm was obtained (Polyimide 10). The thickness of each layer A in the tri-layer film was on the order of 5 to 6 μm, while the layer B was ˜40 μm). The T_{g} of this film was ˜220° C. (for layers A) and ˜350° C. (for layer B). The resulting film was then laminated onto a copper sheet as generally described above using the lamination conditions shown in Table 2. Peel testing was performed on the test sample and the result recorded in Table 2.

### Example 1

For Example 1 (E1), the film of CE1 was used with an adhesion promoter. MEGUM™ W-3295 (DuPont de Nemours, Inc., Wilmington, DE), a waterborne-based one-coat adhesive was diluted to 1.0 wt % solids with deionized water and applied to the copper as described above. The film was laminated at the same temperature and pressure as CE1, and peel testing was performed.

### Example 2

For Example 2 (E2), the film of CE1 was used with an adhesion promoter. To a solution of methanol/deionized water (95/5 v/v) was added PEDTMS (N-[3-(trimethoxysilyl) propyl]ethylenediamine, 1% v/v). The solution was shaken several times and left to age overnight, then applied to the copper as described above. The film was laminated at the same temperature and pressure as CE1, and peel testing was performed.

### Example 3

For Example 3 (E3), the film of CE1 was used with an adhesion promoter. To a solution of methanol/deionized water (95/5 v/v) was added APTMS (3-aminopropyl)triethoxysilane, 1% v/v). The solution was shaken several times and left to age overnight, then applied to the copper as described above. The film was laminated at the same temperature and pressure as CE1, and peel testing was performed.

### Example 4

For Example 4 (E4), an A-B bilayer of the film compositions of CE1 was used with an adhesion promoter. MEGUM™ W-3295 was diluted to 0.5 wt % solids with deionized water and applied to the copper as described above. The film was laminated at the same temperature and pressure as CE1, and peel testing was performed.

### Example 5

For Example 5 (E5), the film of CE1 was used with an adhesion promoter. 1% PEDTMS, as described in E2 was used. The film was laminated at the same temperature and pressure as CE1, and peel testing was performed.

### Example 6

For Example 6 (E6), an A-B bilayer of the film compositions of CE1 was used with an adhesion promoter. 1% MEGUM™ W-3295, as described in E1 was used. The film was laminated at the same temperature and pressure as CE1, and peel testing was performed.

### Example 7

For Example 7 (E7), an A-B bilayer of the film compositions of CE1 was used with an adhesion promoter. To a solution of methanol/deionized water (95/5 v/v) was added APTMS (0.25% v/v). The solution was shaken several times and left to age overnight, then applied to the copper as described above. The film was laminated at the same temperature and pressure as CE1, and peel testing was performed.

### Example 8

For Example 8 (E8), the film of CE1 was used without an adhesion promoter and laminated at a lower temperature and the same pressure as CE1, and peel testing was performed.

Table 2 shows that through the application of an adhesion promoter, in the form of various silane materials, the adhesion of a polyimide layer to a copper surface is improved significantly, in some cases up to a point where this interface is no longer considered to be an interface that can experience adhesive failure. Moreover, Table 2 shows that temperature is a more important variable in determining the effectiveness of the adhesion promoter than pressure.

TABLE 2

| | | | | | Average | |
|---|---|---|---|---|---|---|
| | | | | | Peel | |
| | Peel arm | | Lamination | Lamination | Strength | Calculated |
| | thickness | Adhesion | Temperature | Pressure | Instron | G_{lc} |
| Example | (μm) | promoter | (° C.) | (psi) | (N/m) | (J/m²) |
| CE1 | 48.6 | N/A | 310 | 500 | 353 | 132 |
| E1 | 48.6 | 1% MEGUM ™ | 310 | 500 | 2160 | >751 |
| E2 | 48.6 | 1% PEDTMS | 310 | 500 | 2459 | >824 |
| E3 | 145.8 | 1% APTMS | 310 | 500 | 4316 | >1345 |
| E4 | 97.2 | 0.5% MEGUM ™ | 310 | 500 | 2023 | 602 |
| E5 | 48.6 | 1% PEDTMS | 280 | 500 | 873 | 294 |
| E6 | 97.2 | 1% MEGUM ™ | 310 | 47 | 3891 | >1345 |
| E7 | 97.2 | 0.25% APTMS | 310 | 500 | 1070* | 385 |
| E8 | 51.6 | N/A | 300 | 500 | 1819 | >706 |

### Example 9

For Example 9 (E9), a first polyamic acid solution “A” of a monomer composition ODPA/PMDA (in a molar ratio of 4:1) and RODA was prepared by dissolving the diamine in DMAc with a mechanical stirrer under nitrogen, followed by the addition of the dianhydride powders over a short period of time until a molar stoichiometry of approximately 1:0.97 between amines and anhydride monomers is obtained. The polyamic acid solution was then finished by incrementally adding a 6 wt % solution of PMDA in DMAc to obtain a maximum viscosity of 2500-3000 poise. The polyamic acid solution was then cast on a stainless-steel belt and then dried and imidized by heating in an oven. The resulting film (Polyimide 8) had a thickness of ˜50 μm and a T_{g} of ˜230° C. The film was subjected to double cantilever beam testing to measure the G_{lc} of the interface between 6061 aluminum and the polyimide film.

### Comparative Example 2

For Comparative Example 2 (CE2), a film of Polyimide 4 was laminated with a film of 50FEP by following the double cantilever beam testing procedure, and the G_{lc} of the interface between the two polymer films was measured.

### Example 11

For Example 11 (E11), a first polyamic acid solution “C” of a monomer composition ODPA/PMDA (in a molar ratio of 4:1) and RODA/1,6-diaminohexane (HMD) (in a molar ratio of 2.33:1)) was prepared by dissolving the diamine in DMAc with a mechanical stirrer under nitrogen, followed by the addition of the dianhydride powders over a short period of time until a molar stoichiometry of approximately 1:0.97 between amines and anhydride monomers is obtained. The polyamic acid solution was then finished by incrementally adding a 6 wt % solution of PMDA in DMAc to obtain a maximum viscosity of 2500-3000 poise. A second polyamic acid solution “B” of a monomer composition of BPDA 0.35/PMDA 0.65//PPD 0.13/ODA 0.87 was prepared by following the procedure as described above. Both polyamic acid solutions were co-cast on a stainless-steel belt and then dried and imidized by heating in an oven. A polyimide tri-layer A-B-A film of an overall thickness of ˜25 μm was obtained (Polyimide 11). The thickness of each layer A in the tri-layer film was ˜3 μm, while the layer B was ˜19 μm. The T_{g} of this film was ˜195° C. (for layers A) and ˜350° C. (for layer B). The resulting film was subjected to double cantilever beam testing to measure the G_{lc} of the interface between 6061 aluminum and the polyimide film.

### Comparative Example 3

For Comparative Example 3 (CE3), the film of E11 was laminated to a polyimide film composed of BPDA/PMDA (in a molar ratio of 1.2:1) and ODA (4,4′-oxydianiline) following the T-peel testing procedure. The BPDA/PMDA//ODA film further contained 17 wt % of alumina, which was added to the polyamic acid in the form of a 25 wt % slurry of alumina in DMAc and had a thickness of ˜25 μm. The G_{lc} of the interface between the two polyimide films was measured.

### Example 12

For Example 12 (E12), two films of E11 were laminated together following the T-peel testing procedure. The G_{lc} of the interface between the two polyimide films was measured.

### Example 13

For Example 13 (E13), the film of E11 was laminated following the T-peel testing procedure to a film of Polyimide 12 which was prepared as described in Example 11, but additionally contained 17 wt % of alumina, which was added to the polyamic acid in the form of a 25 wt % slurry of alumina in DMAc. The G_{lc} of the interface between the two polyimide films was measured.

TABLE 3

| | | | Lamination | Lamination | | |
|---|---|---|---|---|---|---|
| | | | Temperature | Pressure | Cure Time | G_{lc} |
| Example | Film 1 | Film 2 | (° C.) | (psi) | (min) | (J/m²) |
| E9 | Polyimide 8 | N/A | 310 | 375 | 60 | >705 |
| CE2 | Polyimide 4 | 50FEP | 274 | 23 | 60 | 108 |
| E11 | Polyimide 11 | N/A | 300 | 250 | 60 | >705 |
| CE3 | Polyimide 11 | Polyimide 5 | 350 | 166 | 20 | 78 |
| E12 | Polyimide 11 | Polyimide 11 | 300 | 250 | 30 | >706 |
| E13 | Polyimide 8 | Polyimide 12 | 310 | 250 | 30 | >706 |

E9 and E11 in Table 3 show that certain polyimide compositions containing RODA display very strong adhesion to 6061 aluminum surfaces.

E12 and E13 in Table 3 additionally show that certain polyimide compositions containing RODA also displayed very strong adhesion to themselves.

CE2 in Table 3 shows that the adhesion of a polyimide film with high T_{g} to fluoropolymer FEP, which is commonly used as an adhesive, is relatively weak in comparison, and, therefore, unlikely to withstand the bending radii previously described without visible damage.

CE3 in Table 3 shows that the adhesion of a polyimide film with high T_{g} to a polyimide film that shows good adhesion to metal and itself is relatively weak in comparison, and therefore unlikely to withstand the bending radii previously described without visible damage.

### Comparative Examples 4 to 6

For Comparative Examples 4 to 6 (CE4-CE6), polyethersulfone (PES Ultrason®, CS Hyde Co., Lake Villa, IL) test samples without any adhesion promoter were prepared for peel testing on smooth copper. Table 4 summarizes the testing of the PES films of CE4 to CE6. After lamination, these films release from the copper sheet with minimal effort, thus, their peel strength is too low to measure, and therefore this material is unlikely to withstand the bending radii previously described without visible damage. As a result, polyethersulfone is unsuitable as an insulative material in direct contact with a conductive element.

### Comparative Examples 7 to 10

For Comparative Examples 7 to 10 (CE7-CE10), polyetheretherketone (PEEK, CS Hyde Co.) test samples with an adhesion promoter (1 wt % MEGUM™ solution) were prepared for peel testing on smooth copper. Films were cut to size (0.50×8″) using the JDC precision sample cutter. Half of the protective cover sheet on the copper was removed leaving a 2×8″ area of exposed copper. The copper was cleaned by wiping the surface with an acetone-soaked non-woven paper towel, followed by an isopropyl alcohol-soaked paper towel. The exposed copper surface was left to dry for 30 minutes under ambient conditions. Excess MEGUM™ solution (1 wt %) was pipetted onto the copper surface and allowed to sit for 30 seconds before the plate was tilted 90 degrees such that excess solution ran off the surface onto a paper towel. The copper plate was air-dried in an up-right position for at least 30 minutes under ambient conditions. The protective adhesive film was then removed and the non-treated side of the coper was cleaned by wiping the surface with an acetone soaked non-woven paper towel, followed by an isopropyl alcohol soaked paper towel. The copper surface was dried for 10 minutes under ambient conditions.

The test pieces were assembled starting with a 1.5×4″ piece of PFA (PerFluoroAlkoxy, 1 mil) film, which was placed at the top of the copper sheet to prevent adhesion between the test strips and copper (creating a peel arm). Four PEEK film test strips (0.5×8″) were placed across the copper sheet (2 on the MEGUM™ treated side, two on the non-treated side). A piece of Kapton@ tape was applied to the bottom of the samples to hold the multi-layer test strips in place. A sheet of polyimide with ultra-high temp release film (NRF-250, 2 mil, Northern Composites, LLC, Hampton, NH) was draped over the film strips with the release side facing the samples. Polyimide 9 (3 mil) was placed on-top of the previous layer, and an additional sheet of polyimide with ultra-high temp release film was placed on-top of Polyimide 9 with the release film facing up. Samples were placed inside a custom sealable framed fixture with a vacuum port. Samples were loaded into a Carver Model M Laboratory press, house vacuum was applied to the vacuum port, and the samples were heated from 100° C. to the final lamination temperature (Table 4). After a 10-minute dwell time at the desired pressure, the samples were cooled to 60° C. under pressure.

Table 4 shows the lamination conditions utilized for the PEEK films. CE7-CE9 examined the effect of varying pressures and peel arm thicknesses. CE10 utilized a 5-minute rapid nitrogen purge followed by a slow nitrogen purge (while vacuum was applied) during the lamination to further reduce the oxygen content. In every experiment with PEEK laminated to copper, portions of the film spontaneously delaminated upon sitting for >10 minutes after lamination. The low adhesion to copper precluded any additional peel-force measurements.

TABLE 4

| | | | | | Average | |
|---|---|---|---|---|---|---|
| | | | | | Peel | |
| | Peel arm | | Lamination | Lamination | Strength | Calculated |
| | thickness | Adhesion | Temperature | Pressure | Instron | G_{lc} |
| Example | (um) | promoter | (° C.) | (psi) | (N/m) | (J/m²) |
| CE4 | 73 | N/A | 225 | 250 | <80* | N/A |
| CE5 | 73 | N/A | 250 | 250 | <80* | N/A |
| CE6 | 73 | N/A | 275 | 250 | <80* | N/A |
| CE7 | 25 | 1% MEGUM ™ | 350 | 20 | <80* | N/A |
| CE8 | 50 | 1% MEGUM ™ | 350 | 125 | <80* | N/A |
| CE9 | 50 | 1% MEGUM ™ | 350 | 90 | <80* | N/A |
| CE10 | 50 | 1% MEGUM ™ | 345 | 80 | <80* | N/A |

*peel strength is less than the minimum peel strength measured on Instron

### Comparative Example 11

For Comparative Example 11 (CE11), a polyimide film composed of PMDA and ODA that additionally contains ˜17 wt % of alumina, and of approximate thickness of 19 μm was dispersion coated on one side with a fluoropolymer coating of tetrafluoroethylene-hexafluoropropylene copolymer (FEP). The dry thickness of the FEP coating was such that the final film thickness was ˜28 μm. The resulting film was then converted into a tape, spirally wrapped with 66% overlap (the fluoropolymer side was facing the conductor) around a rectangular copper conductor (of approximate dimensions 0.057″×0.16″) and heat sealed. The resulting insulated wire was then subjected to an edgewise bend using a R/W of 1.1 and visually inspected for damage. Significant buckling and instances of tape-to-tape delamination were observed in the bent region of the wire. This outcome was expected based on the analysis from Table 1 (Polyimide 3 and 50FEP). Although both layers meet the requirement of an elongation at break value of greater than 60%, the requirement of a ratio of their tensile moduli of greater than 0.7:1 was not met.

### Comparative Example 12

For Comparative Example 12 (CE12), a first polyamic acid solution “A” of a monomer composition ODPA/PMDA (in a molar ratio of 4:1) and RODA was prepared by dissolving the diamine in DMAc with a mechanical stirrer under nitrogen, followed by the addition of the dianhydride powders over a short period of time until a molar stoichiometry of approximately 1:0.97 between amines and anhydride monomers is obtained. The polyamic acid solution was then finished by incrementally adding a 6 wt % solution of PMDA in DMAc to obtain a maximum viscosity of 2500-3000 poise. A second polyamic acid solution “B” of a monomer composition of PMDA/BPDA (in a molar ratio of 1.45:1) and ODA/PPD (in a molar ratio of 1:1.49) was prepared by following the procedure as described above. Both polyamic acid solutions were co-cast on a stainless-steel belt and then dried and imidized by heating in an oven. A polyimide tri-layer A-B-A film with an overall thickness of ˜25 μm was obtained. The thickness of each layer A in the tri-layer film was on the order of 2 to 3 μm. The tri-layer polyimide film was then converted into a tape, spirally wrapped with 66% overlap around a rectangular copper conductor (of approximate dimensions 0.06″×0.12″) and heat sealed. The resulting insulated wire was then subjected to an edgewise bend using a R/W of 0.97 and visually inspected for damage. Significant buckling and instances of delamination were observed in the bent region of the wire. This outcome was expected based on an analysis from Table 1. The composition “B” of the core layer of CE12 is the same as Polyimides 6 and 7 and has a thickness, 19 μm, that is in between that of Polyimide 6 (12 μm) and Polyimide 7 (25 μm), thus, the polyimide core layer of CE12 would not be expected to meet the requirement of an elongation at break value of greater than 60%.

### Example 14

For Example 17 (E17), a first polyamic acid solution “A” of a monomer composition ODPA/PMDA (in a molar ratio of 4:1) and RODA was prepared by dissolving the diamine in DMAc with a mechanical stirrer under nitrogen, followed by the addition of the dianhydride powders over a short period of time until a molar stoichiometry of approximately 1:0.97 between amines and anhydride monomers is obtained. The polyamic acid solution was then finished by incrementally adding a 6 wt % solution of PMDA in DMAc to obtain a maximum viscosity of 2500-3000 poise. A second polyamic acid solution “B” of a monomer composition of PMDA and ODA was prepared by following the procedure as described above. Both polyamic acid solutions were co-cast on a stainless-steel belt and then dried and imidized by heating in an oven. A polyimide tri-layer A-B-A film of an overall thickness of ˜25 μm was obtained. The thickness of each layer A in the tri-layer film was on the order of 2 to 3 μm. The tri-layer polyimide film was then converted into a tape, spirally wrapped with 66% overlap around a rectangular copper conductor (of approximate dimensions 0.06″×0.12″) and heat sealed. The resulting insulated wire was then subjected to an edgewise bend using a R/W of 0.98 and visually inspected for damage. No significant buckling, delamination, or wrinkling was observed in the bent region of the wire. This outcome was expected because, based on an analysis of the compositions from Table 1, the combination of the polyimide core layer (composition based on 100HN) and the outer thermoplastic polyimide layers (composition based on Polyimide 8) meets the requirement of an elongation at break values of greater than 60%, and the requirement of a ratio of their tensile moduli of greater than 0.7.

What is claimed is:

1. An electrically insulated conductor comprising:
an electrically conductive core; and
an insulating wrap around the electrically conductive core, the insulating wrap comprising a base film tape, wherein the base film tape comprises:
a polymer core layer; and
a first thermoplastic polymer outer layer adhered to a first side of the polymer core layer, wherein:
the polymer core layer and the first thermoplastic polymer outer layer each have a glass transition temperature (T_{g}) of 200° C. or higher;
a ratio of a bending radius (R) to a width (W) of the insulated conductor is in a range of from 0.8:1 to 2:1; and
an interlaminar fracture toughness (G_{lc}) of the first thermoplastic polymer outer layer to the conductive core is 200 J/m² or more.

2. The electrically insulated conductor of claim 1, wherein an interlaminar fracture toughness (G_{lc}) of the first thermoplastic polymer outer layer to polymer core layer is 140 J/m² or more.

3. The electrically insulated conductor of claim 1, wherein an average ultimate strain for the base film tape is 60% or more.

4. The electrically insulated conductor of claim 1, wherein an average ultimate strain for the polymer core layer and the first thermoplastic polymer outer layer each are 60% or more.

5. The electrically insulated conductor of claim 1, wherein a ratio of a tensile modulus of the first thermoplastic polymer outer layer to a tensile modulus of the polymer core layer is 0.7:1 or more.

6. The electrically insulated conductor of claim 1, wherein the conductive core comprises conductive wire selected from the group consisting of copper, copper alloys, silver, silver alloys, aluminum, stainless steel.

7. The electrically insulated conductor of claim 1, wherein the conductive core comprises coated copper wire selected from the group consisting of nickel-coated copper alloy wire, tin-coated copper alloy wire and silver-coated copper alloy wire.

8. The electrically insulated conductor of claim 1, wherein the polymer core layer further comprises an electrically insulative, corona resistant composite filler.

9. The electrically insulated conductor of claim 8, wherein the electrically insulative, corona resistant composite filler is present in an amount in a range of from 5 to 30 weight percent, based on the total weight of the polymer core layer.

10. The electrically insulated conductor of claim 8, wherein the electrically insulative, corona resistant composite filler comprises an organic component and an inorganic ceramic oxide component.

11. The electrically insulated conductor of claim 10, wherein the organic component is an organo-siloxane moiety or an organo-metaloxane moiety.

12. The electrically insulated conductor of claim 10, wherein the inorganic ceramic oxide component is selected from the group consisting of silica, alumina, titania, zirconia and mixtures thereof.

13. The electrically insulated conductor of claim 10, wherein a weight ratio of the organic component to the inorganic ceramic oxide component is in a range of from 0.01:1 to 1:1.

14. The electrically insulated conductor of claim 1, wherein the polymer core layer:
has a thermal class rating of 200° C. or higher; and
comprises a polyimide, a poly(amide-imide), a polyaryletherketone, a polyphenylene sulfide, a polyphenylene sulfone, a polyether sulfone, a polyetherimide, or a mixture thereof.

15. The electrically insulated conductor of claim 1, wherein the first thermoplastic polymer outer layer comprises a polyimide, a poly(amide-imide), a polyaryletherketone, a polyphenylene sulfide, a polyphenylene sulfone, a polyether sulfone, a polyetherimide, or a mixture thereof.

16. The electrically insulated conductor of claim 1, further comprising a second thermoplastic polymer outer layer adhered to a second side of the polymer core layer.

17. The electrically insulated conductor of claim 16, wherein the second thermoplastic polymer outer layer comprises a polyimide, a poly(amide-imide), a polyaryletherketone, a polyphenylene sulfide, a polyphenylene sulfone, a polyether sulfone, a polyetherimide, or a mixture thereof.

18. The electrically insulated conductor of claim 1, further comprising an adhesion promoter layer between the insulating wrap and the electrically conductive core.

19. The electrically insulated conductor of claim 18, wherein the adhesion promoter comprises an organo-silane moiety.

20. The electrically insulated conductor of claim 19, wherein the organo-silane moiety is an aminosilane.

21. The electrically insulated conductor of claim 1, wherein:
the first thermoplastic polymer outer layer has a thickness in a range of from 2 to 10 μm; and
the polymer core layer has a thickness in a range of from 12 to 75 μm.

22. The electrically insulated conductor of claim 1, wherein a cross-section profile of the electrically insulated conductor shows good concentricity.

23. The electrically insulated conductor of claim 16, wherein an interlaminar fracture toughness (G_{lc}) of the first thermoplastic polymer outer layer to second thermoplastic polymer outer layer is 140 J/m² or more.
